(19) United States
(12) Patent Application Publication
(10) Pub. No.: US 2005/0193940 A1
(43) Pub. Date: Sep. 8, 2005

(54) Device and method for supporting a flag on a flagpole

(75) Inventor: Paul Swenson, Sandy, UT (US)

Correspondence Address: THORPE NORTH & WESTERN, LLP., 8180 SOUTH 700 EAST, SUITE 200, P.O. BOX 1219, SANDY, UT, 84070, US

(73) Assignee: Colonial Flag

(21) Appl. No.: 11/065,338

(22) Filed: Feb. 23, 2005

Related U.S. Application Data
(60) Provisional application No. 60/546,880, filed on Feb. 23, 2004.

(51) Int. Cl. G09F 17/00

(52) U.S. Cl. 116/174

(57) ABSTRACT

Disclosed is flagpole assembly comprising a flagpole; a flag having a periphery; upper and lower flag couplings configured to couple one side of the periphery of the flag to the flagpole; and at least one flag positioning ring configured to be positioned around the flagpole with a tight fit and between the upper and lower flag couplings and adjacent the upper flag coupling to maintain a substantially fixed position of the upper flag coupling, wherein the at least one flag positioning ring is configured to be removably attachable to the flagpole and independent from the flag and the upper flag coupling.

This application claims priority to the Provisional Application No. 60/546,880 filed on Feb. 23, 2004 in the United States Patent and Trademark office, which application is incorporated by reference herein.

### BACKGROUND

The present invention relates generally to flagpoles. More particularly, the present invention relates to a device for quickly and inexpensively securing and positioning a flag on a flagpole.

Flags are symbols or standards of nations or organizations. Flying a flag is a display of patriotism or allegiance to the entity represented by the flag and is a practice which dates back thousands of years. As such, occasion often arises to display a flag on a flagpole. One way to do so is by using a halyard in conjunction with a pulley or similar device at the top of a flagpole. The halyard runs over the pulley and includes special tackle for attaching a flag to the rope. The flag is raised or lowered by drawing the rope over the pulley after which the rope is usually tied off at an anchor point near the bottom of the flagpole to secure the flag in position. This type of flagpole is generally fixedly mounted and quite tall, necessitating the use of the halyard and pulley to raise the flag to the top. Moreover, this type of flagpole generally requires special hardware and tackle to position the flag properly. Therefore, conventional flagpoles assemblies can be inconvenient when used only occasionally or when a portable flagpole is needed.

Flags can be mounted and positioned on a pole by other means, but this too generally requires specially adapted features. For example, the flagpole may have holes through which ties can be passed to secure the flag to the pole, or the flagpole may have posts to which a flag can be tied. One may choose to purchase a flagpole with this type of specially adapted feature or one may alter an existing pole in a similar manner. Thus, either a designated flagpole or a pole that has been specially altered in some way is usually required to properly display a flag.

Private citizens or other groups may, however, have a desire to fly flags only on certain holidays or occasions. This can be difficult if one does not fly a flag year-round because one must either purchase a flagpole and other necessary hardware or make special modifications to some other pole in order to display the flag properly. This can be expensive, inconvenient, and impractical. What is needed is a cheap, simple alternative. For example, a device that can be used to attach and position a flag quickly on an existing pole without modification or as part of a simple and inexpensive flagpole assembly. Such a device may allow for easy adjustment of flag position on the pole as well as allowing for a high level of portability and flexibility to meet a wide range of flag display needs.

### SUMMARY

It has been recognized that it would be advantageous to develop a device that can be used to attach and position a flag quickly and inexpensively to a pole.

Briefly, and in general terms, the invention is directed to a flagpole assembly including a pole, a flag, flag couplings, and one or more positioning rings. The flag couplings are used to attach the flag to the pole, while the positioning rings are removably placed on the pole adjacent the flag couplings to secure the flag in a desired position on the pole. The invention makes for a very simple and inexpensive flagpole assembly.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a perspective view of a flagpole assembly in accordance with an embodiment of the present invention;

FIG. 2 is a close-up view of the flag couplings and positioning rings of FIG. 1; and

FIG. 3 is a view of a positioning ring according to one embodiment of the invention.

Reference will now be made to the exemplary embodiments illustrated, and specific language will be used herein to describe the same. It will nevertheless be understood that no limitation of the scope of the invention is thereby intended.

### DESCRIPTION

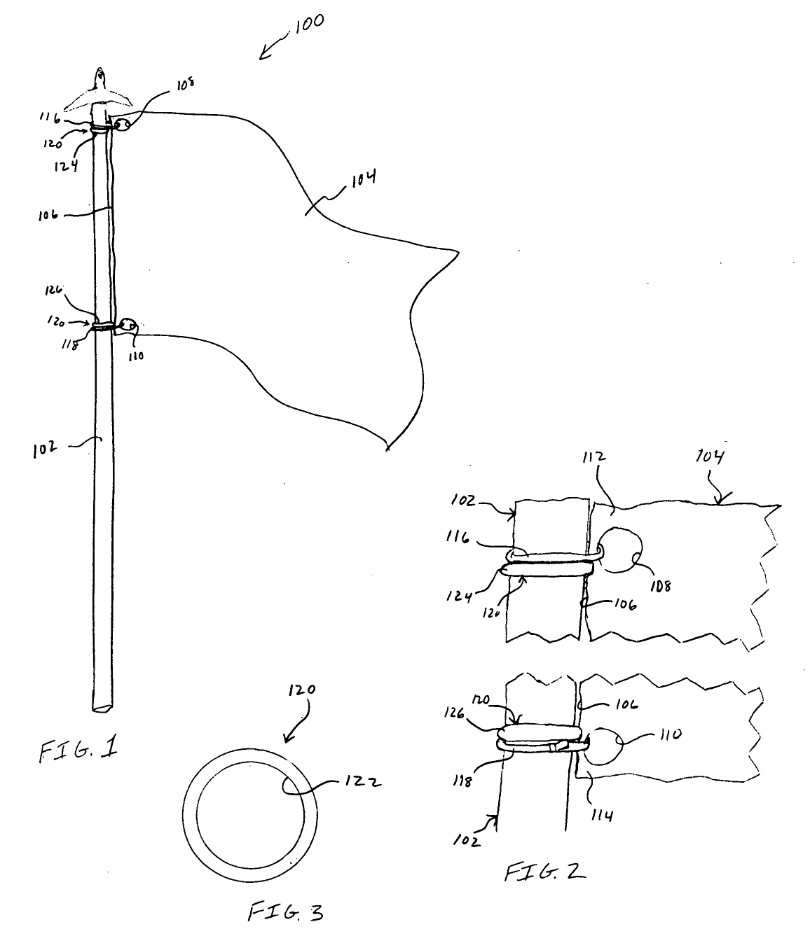

FIGS. 1, 2 and 3 illustrate a flagpole assembly 100 and various components thereof. The flagpole assembly 100 can be of the type for temporary use, such as for displaying flags in front-yards on for example, Flag Day. Such a flagpole assembly 100 can include a flagpole 102, a flag 104, upper and lower flag couplings 116 and 118 and one or more flag positioning rings 120. The one or more flag positioning rings 120 can be configured to position and retain the flag 104 to the flagpole 102 in an upright suspended position. That is, the flag positioning rings 120 can maintain the upper and lower flag couplings 112 and 114 in a fixed position on the flagpole 102. Further, the flag positioning rings 120 facilitate ready assembly of the flag 104 to the flagpole 102 as well as reduce time and cost in production of the flagpole assembly 100.

The flagpole 102 can be an elongated shaft with a circular, square and/or tubular cross-section or any other suitable cross-section and is typically six to eight feet in length, but is not limited to such length. The flagpole 102 can be made from wood, polymeric materials, metal or any other material suitable for flagpole use. The flag 104 is typically rectangular in shape and made from cloth, polymeric material or blends thereof, though not limited to such. The flag 104 can include one peripheral side 106 configured to be suspended adjacent the flagpole 102 to properly display the flag 104. Such peripheral side 106 typically includes an upper and lower eyelet 108 and 110 in respective upper and lower corner portions 112 and 114 of the peripheral side 106 of the flag 104 for coupling the flag 104 to the flagpole 102.

The upper and lower flag couplings 116 and 118 can be any suitable coupling, such as plastic ties, wiring, string, rope, etc. The upper and lower flag couplings 116 and 118 can be configured to extend through respective upper and lower eyelets 108 and 110 and wrap around the flagpole 102. Each flag coupling can then be connected at its opposing end to couple the flag to the flagpole. Typically, such couplings will slide along the flagpole unless restrained by a secure grip or by insertion within a hole at the pole.

The present invention utilizes resilient positioning rings 120 to avoid the need for drilling a hole through the pole. The flag positioning rings 120 can include a ring-like structure with a ring hole 122 sized to fit around the periphery of the flagpole 102. The shape of the flag positioning rings may, therefore, vary according to the shape of the flagpole in use. Such flag positioning rings 120 can be made of a polymeric type material, such as rubber, or any other suitable material that is flexible, resilient and/or elastic. Moreover, because of the simple design and materials, the flag positioning rings will generally be very simple and inexpensive to manufacture. The flag positioning rings 120 can be configured to be removably attachable to the flagpole 102 and further, the flag positioning rings 120 can be independent components from that of the flag 104 and the upper and lower flag couplings 116 and 118. The flag positioning rings 120 can be configured to fit tightly around the flagpole 102 with an elastic-type fit. Such elastic-type fit can be tight enough around the flagpole 102 to withstand the weight of the flag 104 or other forces, including wind, that may undesirably dislodge the flag from its position on the pole. In this manner, the flag 104 can maintain a position with respect to the flagpole 102. Further, the flag positioning rings 120 can be manually manipulated over the surface of the flagpole 102 to manipulate the flag to a desired position with respect to the flagpole 102.

The flagpole assembly 100 can include an upper flag positioning ring 124 and a lower flag positioning ring 126. Each of the upper and lower flag positioning rings can be positioned around the flagpole 102 between the upper and lower flag couplings 116 and 118. The upper flag positioning ring 124 can be disposed adjacent the upper flag coupling 116 and configured to withstand the weight of the flag 104 with the upper flag coupling 116 resting over the upper flag positioning ring 124. The lower flag positioning ring 126 can be spaced from the upper flag positioning ring 124 and manually pushed downward against the lower flag coupling 118 to maintain the flag 104 in a suspended configuration along-side the flagpole 102. The lower flag positioning ring 126 can be an optional component since the flag 104 will generally maintain a suspended position with the weight of the flag 104 in calm weather under normal conditions.

To prevent the flag couplings 116 and 118 from sliding over the positioning rings 124 and 126, the flag couplings may be secured to the flagpole 102 tightly enough such that any slack in the flag couplings is insufficient to allow them to slide over the positioning rings. Alternatively, the width of the positioning rings 124 and 126 can be large enough to prevent the flag couplings 116 and 118 from sliding over the top of the positioning rings and losing the desired flag position. This same result can be achieved in other ways, however, without departing from the scope of the invention.

With the arrangement described in the embodiments above, the flag 104 can be easily secured to the flagpole 102 and maintain a desired position on the flagpole 102. The invention also facilitates a high level of flag display portability to meet a wide variety of flag display needs due to the ease of mounting and positioning of the flag. Any type of pole capable of receiving a positioning ring as previously described can be used as an inexpensive converted flagpole without timely or costly modifications to the pole, including impromptu materials or other commodity materials not generally meant for use as a flagpole. This can include ordinary PVC piping and other types of common piping material, for example.

Positioning rings 124 and 126 are freely adjustable and can be moved along the length of the pole to make room for another flag, for a decorative cap, or for any other reason. In one embodiment, multiple sets of positioning rings 124 and 126 can be used to display multiple flags on a single pole. Moreover, positioning rings 124 and 126 can be easily adjusted to be compatible with any size flag by merely sliding the positioning rings up or down, whereas other flagpoles are either made for a specific flag size or require a more involved adjustment process. Furthermore, such flagpole assembly 100 cuts-down on manufacturing costs and time for production. As indicated above, it is not necessary to drill holes through the flagpole to form coupling openings for coupling the flag to the flagpole as employed conventionally.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the examples.

1. A flagpole assembly, comprising:
a flagpole;
a flag having a periphery;
upper and lower flag couplings configured to couple one side of the periphery of the flag to the flagpole; and
at least one flag positioning ring configured to be positioned around the flagpole with a tight fit and between the upper and lower flag couplings and adjacent the upper flag coupling to maintain a substantially fixed position of the upper flag coupling, the at least one flag positioning ring configured to be removably attachable to the flagpole and independent from the flag and the upper flag coupling.

2. The flagpole assembly of claim 1, wherein a second flag positioning ring is configured to be positioned around the flagpole with a tight fit between the upper and lower flag couplings and adjacent the lower flag coupling to maintain a substantially fixed position of the lower flag coupling, the second flag positioning ring configured to be removably attachable to the flagpole and independent from the flag and the lower flag coupling.

3. The flagpole assembly of claim 1, wherein the position of the flag can be continuously varied along the length of the pole by sliding the at least one flag positioning ring up and down the length of the pole.

4. The flagpole assembly of claim 1, wherein the at least one flag positioning ring is composed of an elastic material.

5. The flagpole assembly of claim 1, wherein the flagpole is any shaft capable of receiving a flag positioning ring to facilitate the display of a flag on the pole without additional hardware or modifications to the shaft.

6. The flagpole assembly of claim 1, wherein the at least one flag positioning ring comprises multiple sets of positioning rings placed on the flagpole, each set being placed between the upper and lower flag couplings of one of multiple flags, allowing multiple flags to be displayed and independently positioned on a single pole.

7. A flagpole assembly configured to display a flag, comprising:
a flagpole;
upper and lower flag couplings configured to couple to one side of a periphery of the flag to the flagpole; and
at least one flag positioning ring configured to be positioned around the flagpole with a tight fit and between the upper and lower flag couplings and adjacent the upper flag coupling to maintain a substantially fixed position of the upper flag coupling, the at least one flag positioning ring configured to be removably attachable to the flagpole and independent from the flag and the upper flag coupling.

8. The flagpole assembly of claim 7, wherein a second flag positioning ring is configured to be positioned around the flagpole with a tight fit between the upper and lower flag couplings and adjacent the lower flag coupling to maintain a substantially fixed position of the lower flag coupling, the second flag positioning ring configured to be removably attachable to the flagpole and independent from the flag and the lower flag coupling.

9. The flagpole assembly of claim 7, wherein the position of the flag can be continuously varied along the length of the pole by sliding the at least one flag positioning ring up and down the length of the pole.

10. The flagpole assembly of claim 7, wherein the at least one flag positioning ring is composed of an elastic material.

11. The flagpole assembly of claim 7, wherein the flagpole is any shaft capable of receiving a flag positioning ring to facilitate the display of a flag on the pole without additional hardware or modifications to the shaft.

12. The flagpole assembly of claim 7, wherein the at least one flag positioning ring comprises multiple sets of positioning rings placed on the flagpole, each set being placed between the upper and lower flag couplings of one of multiple flags, allowing multiple flags to be displayed and independently positioned on a single pole.

13. A method of retaining a flag to a flagpole, the method comprising:
attaching upper and lower flag couplings of a flag to a flagpole; and
removably positioning an at-least-friction-fit flag positioning ring around the flagpole between and independent of the upper and lower flag couplings and adjacent the upper flag coupling to maintain a substantially fixed position of the upper flag coupling.

14. The method of claim 11 comprising the additional step of placing a second flag positioning ring around the flagpole with a tight fit between the upper and lower flag couplings and adjacent the lower flag coupling to maintain a substantially fixed position of the lower flag coupling, the second flag positioning ring configured to be removably attachable to the flagpole and independent from the flag and the lower flag coupling.

15. The method of claim 11, wherein the flag positioning ring is composed of an elastic material.

16. The method of claim 11, wherein the pole is any shaft capable of receiving a flag positioning ring to facilitate the display of a flag on the pole without additional hardware or modifications to the pole.

17. The method of claim 11, wherein multiple sets of positioning rings are placed on the flagpole, each set being placed between the upper and lower flag couplings of one of multiple flags, allowing multiple flags to be displayed and independently positioned on a single pole.
